(19) United States
(12) Patent Application Publication
(10) Pub. No.: US 2018/0325077 A1
(43) Pub. Date: Nov. 15, 2018

(54) DETACHABLE PET KENNEL NET

(71) Applicant: Roderick Brian Carter, Henderson, NV (US)

(72) Inventor: Roderick Brian Carter, Henderson, NV (US)

(21) Appl. No.: 16/036,887

(22) Filed: Jul. 16, 2018

Related U.S. Application Data
(63) Continuation-in-part of application No. 14/792,831, filed on Jul. 7, 2015, now abandoned.

(51) Int. Cl. A01K 1/02; A01K 1/00; E06B 11/02; E06B 9/06

(52) U.S. Cl. CPC A01K 1/02; A01K 1/0064; E06B 2009/002; E06B 9/0692; E06B 11/02

(57) ABSTRACT

A system including a flexible and detachable net implement being configured to be installed on a frame of an entranceway. A plurality of cam straps, each cam strap having a first end segment and a second end segment, wherein each of said first end segment is into engagement with said net implement. A plurality of snap hooks where each snap hook is into engagement with said second end segment of each of said plurality of cam straps, wherein each snap hook is operable for anchoring said net implement. A bracket implement, in which said bracket implement comprises a top end portion and a bottom end portion, wherein said bracket implement is further configured to receive said plurality of snap hooks for anchoring said net implement to the wall of the entranceway frame.

### CROSS-REFERENCE TO RELATED APPLICATIONS

The present continuation-in-part patent application claims priority benefit of the U.S. nonprovisional patent application Ser. No. 14/792,831 entitled “AN APPARATUS FOR A DETACHABLE BARRIER TO AN ENTRANCEWAY” filed 7 Jun. 2015. The contents of this related patent application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to detachable barriers. More particularly, the invention relates to detachable barriers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, homeowners in urban areas may lack a large backyard and/or front yard. However, homeowners may sometimes require an open air space, despite being physically restricted by the amount of land available to them. A solution may be to repurpose a home garage as an outdoor space, but sometimes an open air enclosure is desired.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typical detachable barriers are rigid and/or generally not convenient to store or install.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary detachable barrier, in accordance with an embodiment of the invention; and

FIG. 2 illustrates an exemplary detachable barrier with openings, in accordance with an embodiment of the invention.

FIG. 3 illustrates an exemplary detachable pet retention system, in accordance with an embodiment of the invention.

FIG. 4 illustrates an exemplary wall mount bracket, in accordance with an embodiment of the invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention, and variations thereof, relate to detachable nylon or any variation of nylon barriers. In some embodiments of the invention, a detachable barrier is designed for creating an open air garage enclosure. However, alternative embodiments of the invention may be used to create barriers over any opening.

The present invention will now be described in detail with reference to embodiments thereof as illustrated in the accompanying drawings.

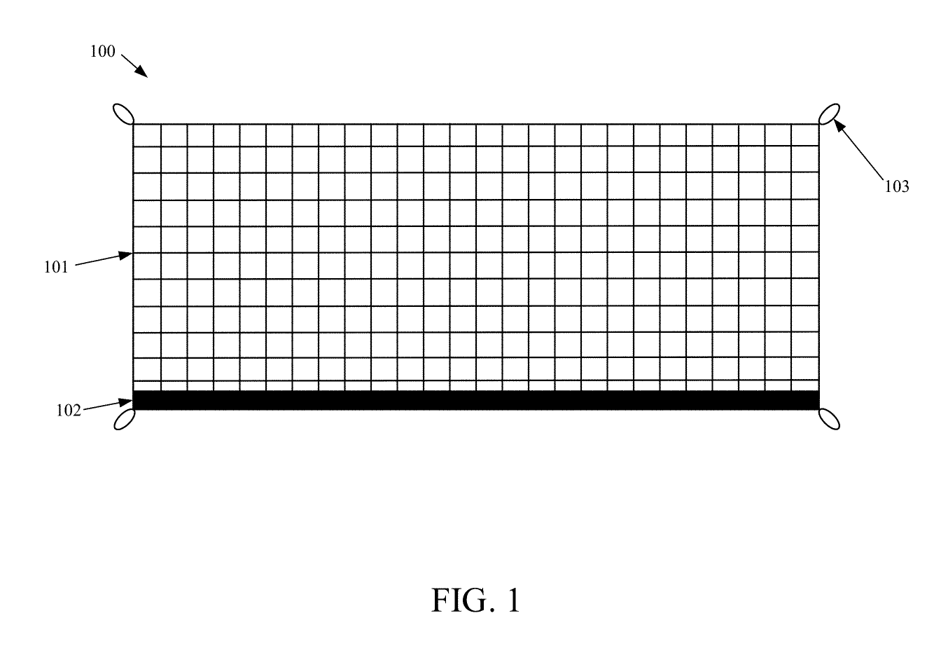

FIG. 1 illustrates an exemplary detachable barrier, in accordance with an embodiment of the invention. Detachable barrier 100 comprises of a net 101, a weighted segment 102, and corner clips 103. Net 101 is designed to allow airflow through detachable barrier 100 while preventing direct access across detachable nylon or any variation of nylon barrier 100. Weighted segment 102 weighs the bottom portion of net 101 against the ground. Corner clips 103 are designed to fasten onto the frame of an entranceway and/or onto a door.

It may be appreciated to a person with ordinary skill in the art that detachable barrier 100 may only partially block an entranceway or opening. Another embodiment of the present invention may have, but not limited to, detachable barrier 100 blocking only the lower half of an entranceway to prevent objects or creatures from passing along the lower half of the entranceway.

It may be appreciated to a person with ordinary skill in the art that net 101 may be designed to block objects or creatures of a certain size. Net 101 may be designed with holes of different sizes and/or shapes to block objects or creatures from passing through net 101. In a non-limiting example, net 101 may have large squares or X design for large dogs and small squares or X's for small dogs. Another embodiment of the present invention may have, but not limited to, a fine mesh to block insects from passing.

It may be appreciated to a person with ordinary skill in the art that net 101 may be made from one or more materials to achieve a desired physical property. Net 101 may be made from materials such as, but not limited to, rubber, nylon, rope in order to achieve a desired elasticity, strength, flexibility. Another embodiment of the present invention may have, but not limited to, net 101 made of nylon to prevent animals from passing detachable barrier 101, while also allowing for detachable barrier 101 to be conveniently rolled up and stored.

It may be appreciated to a person with ordinary skill in the art that weighted segment 102 may be designed to accommodate any form of additional weight. Weighted segment 102 may be, but not limited to, one or more sleeves, pockets, fasteners, that can hold one or more weights. Another embodiment of the present invention may have weighted segment 102 be a pocket that can accommodate excess net 101 as weight.

It may be appreciated to a person with ordinary skill in the art that corner clips 103 may be any fastening mechanism. Corner clips 103 may be, but not limited to, carabineers, interlocking clips, hooks, and Velcro®. Another embodiment of the present invention may have, but not limited to, a user controlled electromagnet to secure detachable barrier 100 across an opening.

It may be appreciated to a person with ordinary skill in the art that there may be any number of corner clips 103 located on detachable barrier 100. One or more corner clips 103 may be located on the perimeter of detachable barrier 100 or anywhere on net 101. In another embodiment Velcro® strips may be located along sides of barrier 100 to prevent a pet from navigating through a side of net 101. Another embodiment of the present invention may have fasteners located on the top of net 101 to better support net 101 when detachable barrier 100 is stretched across an opening.

It may be appreciated to a person with ordinary skill in the art that detachable barrier 100 may be modularly combined with other detachable barriers. In an alternative embodiment of the present invention, a plurality of detachable barriers 100 may be modularly connected via corner clips 103 to form a large detachable barrier system. In still another alternative embodiment of the present invention, a plurality of detachable barrier 100 may be stacked modularly to create a detachable barrier system with smaller holes through the detachable barrier system.

It may be appreciated to a person with ordinary skill in the art that detachable barrier 100 may be applied as a protective barrier over any opening. In an alternative embodiment of the present invention, detachable barrier 100 may cover any opening such as, but not limited to, windows and doors. Net 101 may catch or block any creatures or objects attempting to break through an opening unauthorized.

It may be appreciated to a person with ordinary skill in the art that detachable barrier 100 may be created with a piezoelectric material to generate power from movement. In an alternative embodiment of the present invention, net 101 may be created with a mesh of piezoelectric material and generate power when detachable barrier 100 is moved.

It may be appreciated to a person with ordinary skill in the art that detachable barrier 100 may be created with metal wires to create a security fence. In an alternative embodiment of the present invention, net 101 may be a metal wire mesh connected to a power supply. Electric current will travel through net 101 and shock any creatures that attempt to pass. In still another alternative embodiment of the present invention, net 101 may be a fine wire mesh connected to a power supply. Electric current will travel through net 101 and kill any pests or insects attempting to pass. In still another alternative embodiment of the present invention, a creature or object may be detected when contact is made with net 101. Electric current will travel through net 101 and a processing unit will monitor any changes in electric current that correspond with a creature or object physically contacting net 101.

It may be appreciated to a person with ordinary skill in the art that detachable barrier 100 may be created with resistive heating elements to create a climate controlled enclosure. In an alternative embodiment of the present invention, net 101 may be a resistive wire mesh connected to a power supply. Net 101 will generate heat a desirable amount of heat when powered. Temperature may be controlled by regulating the magnitude and duration of the power running through net 101.

It may be appreciated to a person with ordinary skill in the art that detachable barrier 100 may be designed to support and contain objects. In an alternative embodiment of the present invention, net 101 may be designed to contain a large mass of loose objects such as, but not limited to, rocks, logs, and topsoil within an enclosure. In another alternative embodiment of the present invention, detachable barrier 100 may be mounted vertically along a wall and be used as a climbing apparatus.

It may be appreciated to a person with ordinary skill in the art that detachable barrier 100 may be designed as an extension of an enclosure. Net 101 may be designed such that one or more support pillars may be inserted in net 101 and extend the enclosed space of detachable barrier 100. In an alternative embodiment of the present invention, net 101 may be designed with excess net to be elevated by one or more support pillars to form a tent over an enclosed area.

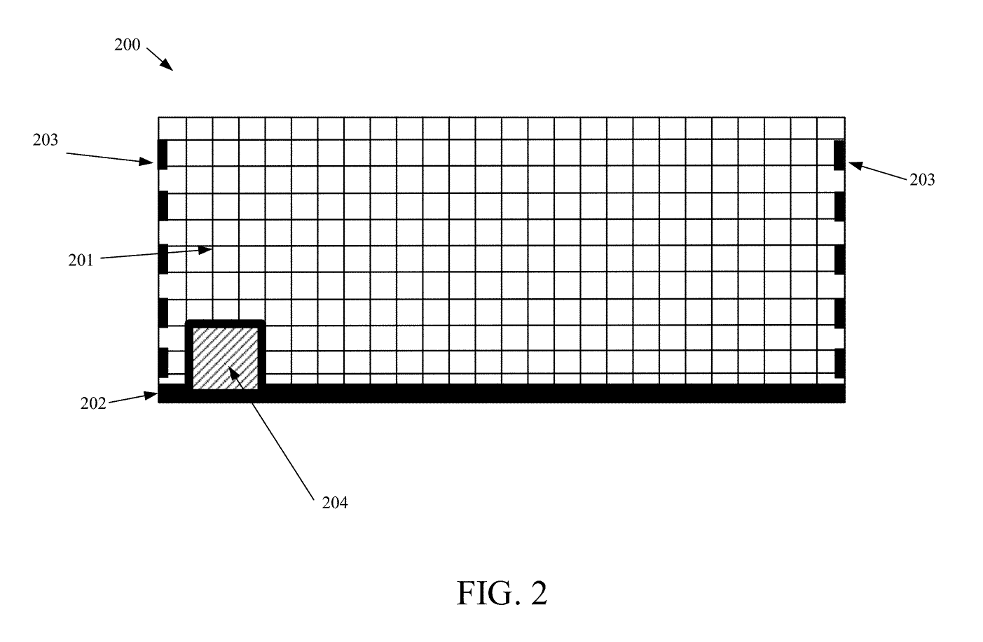

FIG. 2 illustrates an exemplary detachable barrier with openings, in accordance with an embodiment of the invention. Detachable nylon or any variation of nylon mesh with openings 200 comprises of a net 201, a weighted segment 202, Velcro® strips 203, and door cut-out 204. Net 201 is designed to allow airflow through detachable barrier 200 while preventing direct access across detachable barrier with openings 200. Weighted segment 202 weighs the bottom portion of net 201 against the ground. Velcro® strips 203 are designed to fasten onto the frame of an entranceway and/or onto a door. Door cut-out 204 is a sealable opening in net 201 that allows for direct passage through the detachable barrier with openings 200.

It may be appreciated to a person with ordinary skill in the art that door cut-out 204 may be any shape and/or size. Door cut-out 204 may be designed to accommodate, but not limited to, various creatures, objects, and/or vehicles. In another embodiment of the present invention, Door cut-out 204 may be a small rectangular flap to accommodate dogs and cats.

It may be appreciated to a person with ordinary skill in the art that door cut-out 204 may not necessarily be a part of net 201. Door cut-out 204 may be a removable panel or a hole in net 201. In some embodiments, door cut-out 204 may be located in the bottom left or right side of net 201. In some embodiments, door cut-out 204 may be sized accordingly for large or small dogs. In another embodiment of the present invention, door cut-out 204 may be a removable cloth square attached to net 201 via adhesive.

It may be appreciated to a person with ordinary skill in the art that there may be a plurality of door cut-out 204 in net 201. In another embodiment of the present invention, net 201 comprises of a plurality of door cut-outs of different sizes to accommodate, but not limited to, pets, humans, and/or vehicles.

It may be appreciated to a person with ordinary skill in the art that door cut-out 204 may be sealed to net 201 by a variety of means. Door cut-out 204 may be sealed to net 201 by means such as, but not limited to, adhesive, magnets, Velcro®, clips fasteners, snaps strings, ties, etc. In another embodiment of the present invention, door cut-out 204 may be sealed to net 201 by means of a zipper.

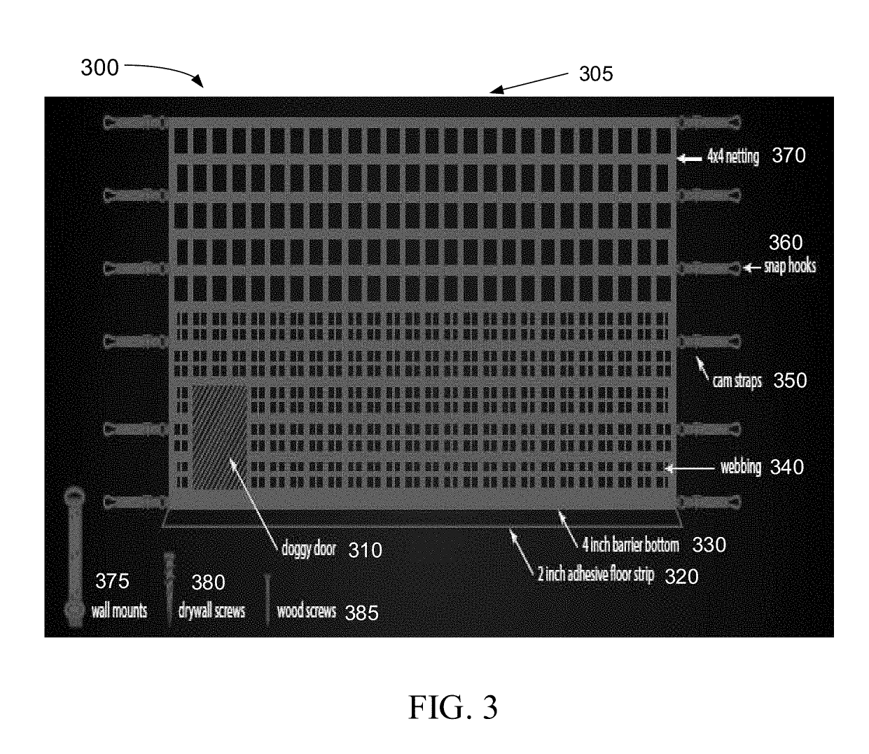

FIG. 3 illustrates an exemplary pet/kennel retention system 300, in accordance with an embodiment of the invention. The pet/kennel retention system 300 may include a detachable net implement 305 with netting 370 and webbing 340, configured to be installed in a frame of a entranceway of a building or any garage door including, but not limited to, single or two car garage door systems. The pet/kennel retention system 300 seals and secures the opening of the garage with the use of cam straps, snap hooks and wall mounted brackets. The net implement 305 may enclose the garage and transform the garage into a safe and secure outdoor environment for pets, such as but not limited to dogs, giving pets additional room to roam and much needed added stimulation. The net implement 305 may stand up to approximately 6 ft tall and featured in various colors including but not limited to red, black, light brown, gray, white, blue, etc. In other embodiments, the pet/kennel net 305 may stand less that 6 ft tall. In some embodiments, the pet/kennel net implement 305 may stand more than 6 ft tall. The pet/kennel net implement 305 may comprise, but not limited to, an industrial heavy-duty nylon fabric material coupled with the cam straps 350 outfitted with the snap hooks 360 attached to the ends of the cam strap 350 for anchoring/clipping/hooking to a support. The cam straps 350 outfitted with the snap hooks 360 may be sewn on both sides of the net implement 305 which may provide a tight seal and proper tautness of the net implement to the garage door. The system may utilize, but not limited to, approximately twelve (12) or more cam straps 350 disposed on each side of the net implement net 305 in the installation. Snap hooks 360 located at an end portion of each cam strap 350 may anchor firmly and/or pulled tight to wall mounted brackets 375 on each side of the net implement to create a rigid nature to the net. The net implement 305 may be attached to the wall mounted brackets 375 on both sides of a garage door system through the cam straps 350 and snap hook fasteners 360 that may firmly hold the net implement in place. Approximately three (3) or more wall mounted brackets 375 on each side of the net implement 305 may be adequate to maintain approximately 900 pounds of hold pressure per side, totaling approximately 1800 pounds of hold pressure on both sides of the net implement 305.

The net implement 305 may further include a pet/doggy door 310 that allows for direct passage of pets through the barrier. Three (3) snap hook implements at the bottom of the pet door that may snap the door 310 closed to prevent pets going through. The pet/doggy door 310 door may be clipped to an upper portion of the pet/doggy door 310 door leaving the pet/doggy door 310 door open. Hook and loop fasteners may run up the left side, right side, and bottom of the pet/doggy door 310 door to typically ensure a proper seal when not in use. The top portion of the net implement 305 may comprised of, but not limited to, proximately four (4) inch squares netting 370, creating an open matrix square design that may allow copious amounts of air to pass through. The bottom half portion of the net may comprise of, but not limited to, proximately two (2) inch squares webbing 340 configured to generally make certain that small pets may not escape. The net implement 305 may further include industrial strength ground adhesive hook and loop strip for added barrier protection that may seal the net implement to a garage floor. The net implement 305 may fully extend from the ground to the top of a garage door opening, leaving roughly a foot of space to make certain a non-interference of the garage door railing system that curves at a top of all garage door systems. A liner 330 may run the bottom of the net implement 305 including but not limited to a proximate four (4) inch liner 330 to provide additional support and may keep the bottom of the net strong which may be adequate to stop a pet from burrowing underneath the net implement 305. An adhesive strip 320 including but not limited to a proximate two (2) inch adhesive floor strip 320 may adhere the net implement 305 bottom to a floor surface which may add barrier secureness and/or may further deter pets from burrowing underneath the net.

In some embodiments, the pet/kennel retention system 300 may be easily stored by unsnapping one side of the net implement 305 and using the cam straps 350 to neatly roll up and tie the net implement 305 together when not in use. The net implement 305 may be hanging to one side while not in use neatly rolled up, or taken down rolled up and may be tied with the cam strap 350 and stored away.

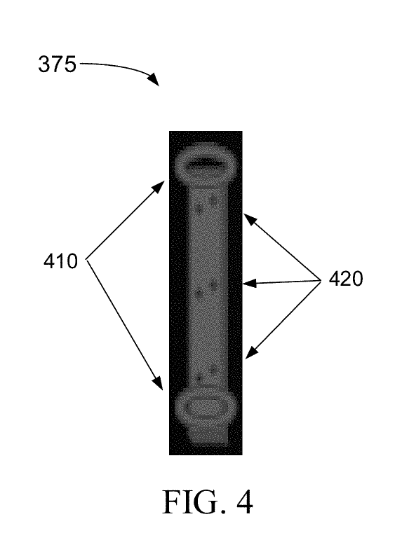

FIG. 4 illustrates an exemplary wall mounted bracket 375, wherein said wall mounted bracket 375 is configured to support the detachable net implement 305, in accordance with an embodiment of the invention. Three (3) or more wall mounted brackets 375 in each side of the net implement 305 may provide adequate support for the net implement. Each of the wall mounted brackets 375 may have a length of approximately fourteen (14) and a half (½) inches. Each of the wall mounted brackets 375 may include two ring implements 410 and six staggered drill points 420. The two ring implements 410, one on the top and one on the bottom of the bracket 375 may provide for the snap hook fasteners 350 to clip to. The six drill points 420 being staggered on a proximate central portion of the net implement 305 may accept drywall screws 380, wood screws 385 and/or anchors for mounting the bracket 375 on a wall and wherein each staggered drill point 420 may hold up to approximately 50 pounds of hold pressure. By staggering the drill points 420 and thereby the drywall screw 380 locations, each wall mounted bracket 375 may uniformly maintain approximately 300 pounds of hold pressure. Three (3) wall mounted brackets 375 on each side of the net implement 305 provides six (6) rings for each of the six (6) snap hooks 360 to clip on to and may maintain approximately 900 pounds of hold pressure per side, totaling approximately 1800 pounds of hold pressure on both sides of the net implement 305.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112 (6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing detachable barriers according to the present invention will be apparent to those skilled in the art. Various aspects of the invention have been described above by way of illustration, and the specific embodiments disclosed are not intended to limit the invention to the particular forms disclosed. The particular implementation of the detachable barriers may vary depending upon the particular context or application. By way of example, and not limitation, the detachable barriers described in the foregoing were principally directed to garage door screen implementations; however, similar techniques may instead be applied to home security, portable barriers, and outdoor enclosures, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a net implement comprising a rectangular shape having a width and a height, wherein said net implement is operable for providing an enclosed environment for pets, and wherein said net implement is configured to be installed on a frame of an entranceway;
a plurality of cam straps, each cam strap having a first end segment and a second end segment, wherein each of said first end segment is into engagement with said net implement;
a plurality of snap hooks, each snap hook is into engagement with said second end segment of each of said plurality of cam straps, wherein each snap hook is operable for anchoring said net implement; and
a bracket implement, in which said bracket implement comprises a top end portion and a bottom end portion, wherein said bracket implement being configured to be mounted on a wall of the entranceway frame, and wherein said bracket implement is further configured to receive said plurality of snap hooks for anchoring said net implement to the wall of the entranceway frame.

2. The system as recited in claim 1, further comprising a staggered drill point implement disposed in said bracket implement, each drill point is configured to accept at least one of, a drywall screw, an anchor, and a wood screw, wherein said staggered drill point implement is configured to mount said bracket implement on the wall with at least one of said drywall screw, anchor, and wood screw.

3. The system as recited in claim 2, in which said staggered drill point implement comprises at least six (6) or more staggered drill points.

4. The system as recited in claim 2, further comprising a ring implement, in which said ring implement comprises at least two (2) or more rings, a first ring being disposed at said top end portion of said bracket implement and a second ring being disposed at said bottom end portion of said bracket implement, each ring being operable for anchoring said snap hook.

5. The system as recited in claim 4, in which said plurality of cam straps comprises at least twelve or more cam straps, six or more cam straps being disposed at each side of said net implement.

6. The system as recited in claim 5, in which said plurality of snap hooks comprises at least twelve or more snap hooks corresponding to number of said twelve or more cam straps.

7. The system as recited in claim 4, in which said bracket implement comprises at least six or more wall mounted brackets, three or more wall mounted brackets being disposed at each side of said net implement.

8. The system as recited in claim 4, further comprising a bottom lining implement joined to a bottom section of said net implement, said bottom lining implement comprises at least four or more inches of lining material that is configured to deter pets from burrowing underneath said net implement.

9. The system as recited in claim 8, further comprising an adhesive floor strip being configured to be operable for adhering said bottom section of said net implement to a floor surface to further deter pets from burrowing underneath the net.

10. The system as recited in claim 1, further comprising a pet door implement, wherein said pet door implement is configured to be operable for allowing direct passage of pets through said net implement.

11. The system as recited in claim 10, in which said pet door implement comprises at least a snap hook implement disposed on a bottom of said pet door implement to snap said door closed.

12. The system as recited in claim 11, in which said pet door implement further comprises at least a hook and loop fastener that runs up a left side, a right side, and a bottom side of said pet door implement to generally ensure a proper seal when said pet door implement is not in use.

13. The system as recited in claim 10, in which a top portion of said net implement comprises a proximate four (4) inch square netting.

14. The system as recited in claim 13, in which a bottom half portion of said net implement comprises a proximate two (2) inch square webbings, whereby said webbings are configured to prevent small pets from escaping.

15. A system comprising:
means for enclosing a garage into a generally safe and secure outdoor environment for pets;
means for engaging said enclosing means to the frame of an entranceway;
means for anchoring said enclosing means;
means for receiving said anchoring means;
means for mounting said anchor receiving means on a wall;
means for engaging a bottom of said enclosing means to a floor surface; and
means for allowing direct passage of pets through said enclosing means.

16. A system comprising:
a net implement comprising a rectangular shape having a width and a height, wherein said net implement is operable for providing an enclosed environment for pets, and wherein said net implement is configured to be installed on a frame of an entranceway;
a plurality of cam straps, each cam strap having a first end segment and a second end segment, wherein each of said first end segment is into engagement with said net implement;
a plurality of snap hooks, each snap hook is into engagement with said second end segment of each of said plurality of cam straps, wherein each snap hook is operable for anchoring said net implement;
a bracket implement, in which said bracket implement comprises a top end portion and a bottom end portion, wherein said bracket implement being configured to be mounted on a wall of the entranceway frame, and wherein said bracket implement is further configured to receive said plurality of snap hooks for anchoring said net implement to the wall of the entranceway frame; and
a pet door implement, wherein said pet door implement is configured to be operable for allowing direct passage of pets through said net implement, in which said pet door implement comprises at least a snap hook implement disposed on a bottom of said pet door implement to snap said door closed.

17. The system as recited in claim 16, further comprising a staggered drill point implement disposed in said bracket implement, wherein said staggered drill point implement is configured to be operable for mounting said bracket implement on the wall with at least one of, a drywall screw, an anchor, and a wood screw.

18. The system as recited in claim 17, further comprising a ring implement, in which said ring implement comprises at least two (2) or more rings, a first ring being disposed at said top end portion of said bracket implement and a second ring being disposed at said bottom end portion of said bracket implement, each ring being operable for anchoring said snap hook.

19. The system as recited in claim 18, further comprising a bottom lining implement joined to a bottom section of said net implement, said bottom lining implement comprises at least four or more inches of lining material that is configured to deter pets from burrowing underneath said net implement.

20. The system as recited in claim 19, in which a top portion of said net implement comprises a proximate four (4) inch square netting and a bottom half portion of said net implement comprises a proximate two (2) inch square webbings, whereby said webbings are configured to prevent small pets from escaping.
